(19) United States
(12) Patent Application Publication
(10) Pub. No.: US 2003/0234863 A1
(43) Pub. Date: Dec. 25, 2003

(54) Environmental change auto-detection digital camera

(76) Inventor: Chin-Hsin Yang, Taipei Hsien (TW)

Correspondence Address: FISH & RICHARDSON PC, 225 FRANKLIN ST, BOSTON, MA, 02110, US

(21) Appl. No.: 10/174,627

(22) Filed: Jun. 19, 2002

(51) Int. Cl. H04N 7/18

(52) U.S. Cl. 348/152

(57) ABSTRACT

An environmental change auto-detection digital camera. In the present invention, the digital image acquisition device acquires a current image every predetermined interval, the control unit stores the current image in the storage unit and replaces the reference image in the register with the current image for comparison in the next time only if the correlation the current image and the reference image does not exceed the predetermined mount, and then turns off the digital image acquisition device. Alternately, the control unit only replaces the reference image in the register with the current image and then turns off the digital image acquisition device if the correlation exceeds the predetermined mount.

### BACKGROUND OF THE INVENTION

1. Field of the Invention

The present invention relates in general to a digital camera. In particular, the present invention relates to an environmental change auto-detection digital camera.

2. Description of the Related Art

Generally, in a conventional security system, a video recorder is used to continuously record an image of a scanned region and store the recorded video even if the images are changeless. Therefore, the conventional security system needs to provide power to the video recorder continuously, so the power consumption is substantial. Furthermore, most of the recorded video shows the same images repeatedly.

Typically, conventional digital cameras have a self-timer mode. For example, the camera will wait three or ten seconds after the shutter-release button is pressed before taking a picture. However, the memory in a conventional camera may fill quickly if the camera takes a picture every three or ten seconds without determining the images are the same. The camera will stop taking pictures when the memory is full, at which the camera will not record changes in the environment anymore. Furthermore, many identical pictures may be stored into the memory. In addition, the camera must be kept in a stand by mode if the camera takes a picture every one hour or more, such that power consumption also very large. If the camera is operating on battery power, the camera will stop taking pictures when power runs out. In this case, the camera cannot record changes in the environment anymore.

### SUMMARY OF THE INVENTION

It is an object of this invention to provide an environmental change auto-detection digital camera and a method to detect environmental change.

In the present invention, the control unit stores the current image in the storage unit and replaces the reference image in the register with the current image for comparison in the next time only if the correlation the current image and the reference image does not exceed the predetermined a mount, and then turns off the digital image acquisition device. Therefore, the present invention can decrease power consumption and avoid repeatedly storing the same images into the memory. In this way, the present invention can record environmental change for a longer time.

The present invention is comprised of a timer unit, a digital image acquisition device, a control unit and a storage unit. The timer unit outputs an enable signal every predetermined interval. The digital image acquisition device acquires a current image. The storage unit stores image data, and the control unit enables the digital image acquisition device to acquire the current image when receiving the enable signal. Further the control unit then detects the correlation between the current image and a reference image in a register. The control unit stores the current image in the storage unit and replaces the reference image in the register with the current image if the correlation does not exceed the predetermined mount. Alternately, the control unit only replaces the reference image in the register with the current image if the correlation exceeds a predetermined amount.

In the method of the present invention, a current image is acquired every predetermined interval. Next, the correlation between the current image and a reference image in register is detected. The current image is stored in the storage unit and the reference image in the register is replaced with the current image if the correlation does not exceed a predetermined mount. Alternately, the reference image is replaced with the current image if the correlation exceeds the predetermined amount.

### BRIEF DESCRIPTION OF THE DRAWINGS

FIG. 1 is a schematic diagram illustrating the environmental change auto-detection digital camera of the present invention.

FIG. 2 shows a process flow of the present invention.

### DETAILED DESCRIPTION OF THE INVENTION

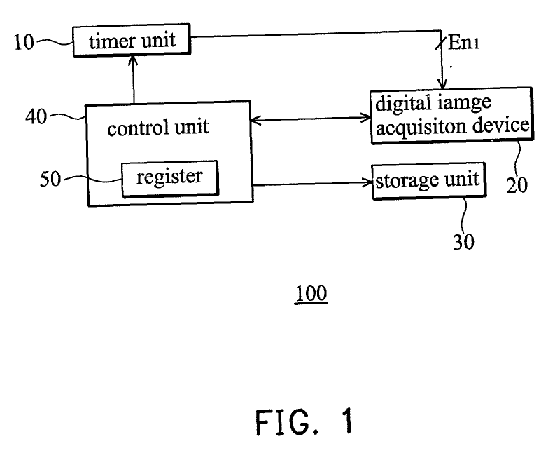

FIG. 1 is a schematic diagram illustrating the environmental change auto-detection digital camera of the present invention. The environmental change auto-detection digital camera 100 of the present invention is comprised of a timer unit 10, a digital image acquisition device 20, a control unit 40 and a storage unit 30. The timer unit 10 outputs an enable signal En1 every predetermined interval. The digital image acquisition device 20 acquires a current image. The storage unit 30 stores image data, and the control unit 40 enables the digital image acquisition device 20 to acquire the current image when receiving the enable signal En1. Further the control unit 40 then detects the correlation between the current image and a reference image. The control unit 40 stores the current image into the storage unit 30 and replaces the reference image with the current image if the correlation does not exceed the predetermined mount. Alternately, the control unit 40 only replaces the reference image with the current image if the correlation exceeds the predetermined mount.

The timer unit 10 outputs an enable signal every predetermined interval T. For example, the predetermined interval T can be 5, 10, 30,. 60 or 90 seconds, and the predetermined interval is adjusted by the timer unit according to the user's requirement.

The digital image acquisition device 20, for example, is a digital camera that has image capture device such as a CMOS sensor and the like. The digital image acquisition device 20 wakes up to acquire a current image after the control unit 40 receives the enable signal En1. The storage unit 30 can be any type of memory for storing image data. In this case of the present, the storage unit 30 is a static random access memory.

In this embodiment, the control unit is a microprocessor coupled to the timer unit 10, digital image acquisition device 20 and the storage unit 30. In additional, the control unit 40 further comprises a register 50 for storing the reference image.

The control unit 40 enables the digital image acquisition device to wake up for acquiring a current image after receiving the enable signal En1. Next, the control unit 40 detects the correlation between the current image and the reference image. The control unit 40 stores the current image into the storage unit 30 and replaces the reference image in the register 50 with the current image for comparison in the next time if the correlation does not exceed a predetermined a mount. Alternately, the control unit 40 only replaces the reference image with the current image for comparison in the next time if the correlation exceeds the predetermined mount.

The control unit 40 further outputs an alarm signal and turns off the digital image acquiring device 20 when the storage unit 30 is full. Moreover, the environmental change auto-detection digital camera 100 of the current image also comprises a voice unit (not shown), for example, a speaker to broadcast an audio signal, for example a voice message.

If the correlation between the current image and the reference image exceeds predetermined a mount, then the frame difference between the current image and the reference image is small. In this case, most of the pixel data in the current image is the same as the pixel data in the reference image, e.g., the current image is similar to the reference image. Alternately, if the correlation between the current image and the reference image does not exceed the predetermined mount, then frame difference between the current image and the reference image is large. In this case, most of the pixel data in the current image is different from the pixel data in the reference image, e.g., the current image is different from the reference image. According to the present invention, the control unit 40 stores the current image into the storage unit 30 and replaces the reference image in the register 50 with the current image for comparison in the next cycle if the correlation does not exceed the predetermined mount. Alternately, the control unit 40 only replaces the reference image with the current image for comparison in the next cycle if the correlation exceeds the predetermined mount. Therefore, different images may are stored into the memory, but identical or nearly-identical are not. Of course the correlation between two images can be adjusted according to different applications. In this case, the current image and the reference image are both digital image data.

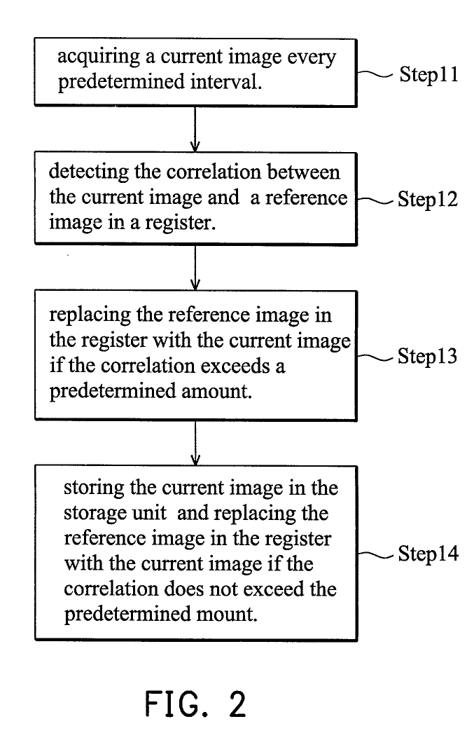

Turning to FIG. 2, FIG. 2 shows a process flow of the present invention. In this case of the present invention, the predetermined interval is 15 seconds. The timer unit 10 outputs an enable signal every 15 seconds to wake up the digital image acquisition device 20. In step 11, the digital image acquisition device 20 acquires a current image immediately after receiving the enable signal. Next, in step 12, the control unit 40 detects the relation between the current image and a reference image. In the step 13, the reference image in the register is replaced with the current image if the correlation exceeds a predetermined amount. Alternately, the current image is stored in the storage unit and is replaced the reference image in the register with the current image if the correlation does not exceed the predetermined mount. The control unit 40 then enables the digital image acquisition device 20 to turn off to wait next 15 seconds. Wherein, the control unit 40 outputs an alarm signal to a voice unit to broadcast a voice message when the current image cannot be stored in the storage unit 30, for example, the storage unit is full, and then turns off the digital image acquiring device 20.

Therefore, the present invention only stores different images into the memory, thereby avoiding the memory being filled quickly. Further, the present invention turns off after replacing the reference image parameter by the current image parameter such that the present invention does not stay in the stand by mode all the time, thereby decreasing power consumption.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An environmental change auto-detection digital camera, comprising:
a timer unit for outputting an enable signal at predetermined intervals;
a digital image acquisition device for acquiring a current image;
a storage unit for storing image data; and
a control unit for enabling the digital image acquisition device to acquire the current image according to the enable signal, and to detect the correlation between the current image and a reference image;
wherein the control unit stores the current image in the storage unit and replaces the reference image in the register with the current image if the correlation does not exceed predetermined a mount, and the control unit replaces the reference image in the register with the current image if the correlation exceeds the predetermined amount.

2. The environmental change auto-detection digital camera as claimed in claim 1, wherein the control unit is a microprocessor.

3. The environmental change auto-detection digital camera as claimed in claim 1, the control unit further comprises a register for storing the reference image.

4. The environmental change auto-detection digital camera as claimed in claim 1, wherein the digital image acquisition device turns off after replacing the reference image with the current image.

5. The environmental change auto-detection digital camera as claimed in claim 1, wherein the predetermined interval is adjustable.

6. The environmental change auto-detection digital camera as claimed in claim 1, wherein the timer unit is a timer.

7. The environmental change auto-detection digital camera as claimed in claim 1, wherein the storage unit is a static random access memory.

8. The environmental change auto-detection digital camera as claimed in claim 1, the control further outputs an alarm signal when the storage unit is full.

9. The environmental change auto-detection digital camera as claimed in claim 8, the digital image acquisition device turns off when the storage unit is full.

10. The environmental change auto-detection digital camera as claimed in claim 8, further comprising a voice unit to broadcast a voice message.

11. The environmental change auto-detection digital camera as claimed in claim 10, wherein the voice unit is a speaker.

12. A method for detecting environmental change, comprising:
acquiring a current image every predetermined interval;
detecting the correlation between the current image and a reference image in a register;
replacing the reference image in the register with the current image if the correlation exceeds a predetermined amount; and
storing the current image in the storage unit and replacing the reference image in the register with the current image if the correlation does not exceed the predetermined mount.

13. The method as claimed in claim 12, further comprising a step of turning off after replacing the reference image with the current image.

14. The method as claimed in claim 12, further comprising a step of outputting an alarm signal when the current image cannot be stored.
